(19) United States
(12) Patent Application Publication
(10) Pub. No.: US 2009/0052637 A1
(43) Pub. Date: Feb. 26, 2009

(54) System and method for storing and reading answers and records of telephone voice via internet

(75) Inventor: Ken Kao, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 11/892,198

(22) Filed: Aug. 21, 2007

(51) Int. Cl. H04M 11/00

(52) U.S. Cl. 379/88.17; 379/88.18

(57) ABSTRACT

In a system and a method for storing and reading answers and records of telephone voice via Internet, the system is built among a local telephone, a network device, a public switched telephone network (PSTN), an Internet, a server and a database. The network device is connected to the local telephone, PSTN and Internet. The server is connected to the network device via the Internet. If the local telephone and the PSTN establish a telephone connection, the network device will read a phone content and transmit and save the phone content to the server. If an incoming call is not picked up by the local telephone within a predetermined time or a predetermined number of rings, the network device will read a response content pre-stored in the server and reply the call via the PSTN, and transmit and store the message content transmitted from the PSTN to the server.

### FIELD OF THE INVENTION

The present invention relates to a system and a method for storing and reading telephone voice, and more particularly to a system and a method for storing and reading answers and records of telephone voice via Internet so as to achieve voice recording and answering functions and enable user to easily acquire phone content or message content at a remote end via the Internet.

### BACKGROUND OF THE INVENTION

Call recorders and answering machines are terminal equipments connected to local telephones, which connect to a public switched telephone network (PSTN). If a phone call is made to an office, a home or a user's local telephone connect to a call recorder and an answering machine and picked up by a person, then the call recorder will start recording a voice content of the phone call. When a user of the call recorder intends to listen to the voice content of a previous phone conversation, the user can play back the recorded voice content through the call recorder to search for important pieces of information in the conversation. If nobody answers the phone call, the answering machine will automatically start playing back a greeting (such as “Hi, I am not available to answer your phone now. Please leave message”) and allow the caller to record a message within a predetermined time (usually from tens of seconds to a minute). After the caller has completed replying and leaving a message and the user of the answering machine discovers the message, the content of message can be played back through the answering machine, so that the user of the answering machine can reply the incoming call according to the message without missing an important phone call. Based on the foregoing advantages, call recorders and answering machines have been used extensively in offices, organizations or individual users' places.

In general, there are two ways of recording voices in traditional call recorders and answering machines. In a traditional analog method, analog call recorder and answering machines transfer a recorded voice signal to a magnetic tape, and then operate the magnetic tape to a recording position of a voice signal through a magnetic tape rotating mechanism of the call recorder or the answering machine to play back the recorded voice for the users. Since the analog call recorder and answering machines use magnetic tape as storage medium, therefore the sound recording quality will become increasingly lower as the number of times of using the magnetic tape and the number of times of being rubbed by friction increase, and the aforementioned factor will cause problems to consumers who require a large quantity of sound recording. To overcome the shortcoming of the aforementioned analog call recorder and answering machine, manufacturers introduced a digital call recorder and answering machine, and the main difference of a digital machine and an analog machine resides on that the digital call recorder and answering machine utilizes memory (such as RAM or FLASH) as storage medium for the sound recording, but the digital call recorder and answering machine is restricted by its memory capacity in practical applications, and thus the call recorder or answering machine using digital voice recording can record voices for approximately ten minutes only, but cannot satisfy the users' requirements. If a user wants to listen to the stored digital sound recording, the user can play the recorded voice from the digital call recorder or answering machine only, but the user cannot transfer the recorded sound to another playback device.

In view of the shortcomings of the aforementioned two types of traditional call recorder and answering machines, the convenience of use is not as good. Regardless of analog or digital call recorders or answering machines, the common drawback is their high price. With the price of the mobile communication devices tending to be lower and more popular, the price of the call recorder and answering machine becomes one of the main factors that consumers are unwilling to purchase such mobile communication devices. Since a vast majority of consumers expect a reasonable price and a user-friendly, multifunctional and well-designed product when they purchase a product, therefore it is an important subject for manufacturers to thoroughly overcome the existing shortcomings of various kinds of call recorders and answering machines and provide a product with diversified functions. Obviously, finding a way of overcoming the shortcomings of the prior art becomes an important subject for manufacturers of the related industry.

### SUMMARY OF THE INVENTION

In view of the shortcomings on the use and price of traditional call recorders and answering machines, the inventor of the present invention based on years of experience in the related industry to conduct extensive researches and experiments, and finally developed a system and a method for storing and reading answers and records of telephone voice via Internet.

It is a primary objective of the present invention to provide a system for storing and reading answers and records of telephone voice via Internet, the system is built among at least one local telephone, a network device, a public switched telephone network (PSTN), an Internet, a server and a database wherein the network device is connected separately to the local telephone, the public switched telephone network (PSTN) and the Internet, and the server is connected to the network device via the Internet. If the local telephone and the public switched telephone network (PSTN) establish a telephone connection, such as a user of a local telephone dials a call to another user at a remote end, or a user of the local telephone receives a phone call from another user at a remote end, the network device will read a phone content and transmit and save the phone content to the server. If a user does not pick up an incoming call from the local telephone within a predetermined time (such as 30 seconds) or a predetermined number of rings, the network device will read a section of response contents pre-stored in the server and reply the call via the public switched telephone network (PSTN), and transmit and store the message content transmitted from the public switched telephone network (PSTN) to the server, wherein the message content is a message left by a user at a remote end. Therefore, consumers can just use the network device to achieve voice recording and answering functions and read the phone content or the message content at a remote end via the Internet easily without the need of purchasing the expensive call recorder or answering machine.

Another objective of the present invention is to provide a method of storing and reading answers and records of phone voice via Internet, and the method is applied to a network voice recording and answering system. If the network device detects any one of the local telephones being situated at a calling status via the public switched telephone network (PSTN) or any one of the local telephones is receiving an incoming call or dialing a call and being in a phone conversation, the network device will start a telephone recording mechanism to receive a phone content between the local telephone and the public switched telephone network (PSTN), and upload and store the phone content to the server via the Internet, so as to achieve the purpose of recording a phone content of an incoming call dialed to the local telephone or a phone content of a call dialed from the local telephone to another phone.

A further objective of the present invention is to provide a network device that starts a telephone answering mechanism if the network device detects an incoming call not answered by a local telephone within a predetermined time, and reads a response content pre-stored in a server via the Internet, and outputs the response content to a public switched telephone network (PSTN) to reply the incoming call. If the network device receives a message content transmitted from the public switched telephone network (PSTN), the network device will upload and store the message content to the server to achieve the voice answering and recording function easily.

Since all phone contents and message contents are stored in a server on the Internet via the Internet, the invention not only achieves the voice recording and answering functions for saving a large quantity of data by the network device easily, without requiring consumers to purchase expensive recorders or answering machines, but also users can read the phone content and the message content from the server anywhere via Internet, and thus the invention can greatly improve the convenience of using the voice recording and answering functions.

To make it easier for our examiner to understand the objective, technical characteristics and effects of the present invention, preferred embodiments will be described with accompanying drawings as follows.

### BRIEF DESCRIPTION OF THE DRAWINGS

FIG. 1 is a schematic view of a structure of a system for storing and reading telephone voice answering and recording in accordance with the present invention;

FIG. 2 is a flow chart of a network voice answering and recording in accordance with the present invention; and

FIG. 3 is another flow chart of a network voice answering and recording in accordance with the present invention.

### DETAILED DESCRIPTION OF THE PREFERRED EMBODIMENTS

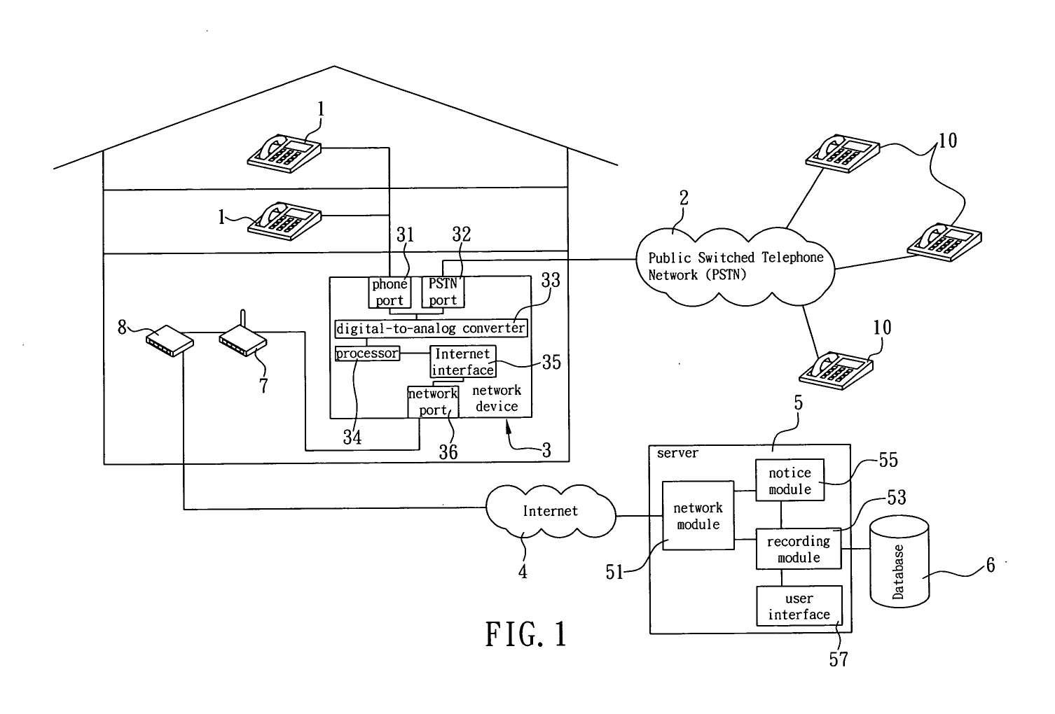

Referring to FIG. 1 for a system and a method for storing and reading answers and records of telephone voice via Internet in accordance with the present invention, the system comprises at least one local telephone 1, a public switched telephone network (PSTN) 2, a network device 3, an Internet 4, a server 5 and a database 6, wherein the local telephone 1 is connected to the public switched telephone network (PSTN) 2, and the network device 3 is installed between the local telephone 1 and the public switched telephone network (PSTN) 2, and the network device 3 is connected to the server 5 via the Internet 4, and the server 5 is connected to the database 6. If the network device 3 detects a telephone connection established between the local telephone 1 and the public switched telephone network (PSTN) 2, such as a call is dialed from the local telephone 1 to another local telephone 10 at a remote end, or the local telephone 1 receives an incoming call from a local telephone 10 at a remote end, the network device 3 will start a telephone recording mechanism to read a phone content between the local telephone 1 and the public switched telephone network (PSTN) 2 and transmit and store the phone content to the server 5.

If the network device 3 detects an incoming call which is not answered by the local telephone 1 within a predetermined time, the network device 3 will start a telephone message mechanism and read a response content pre-stored in the server 5, and transmit the response content to the public switched telephone network (PSTN) 2 to reply the incoming call, and then transmit and store the message content received from the public switched telephone network (PSTN) 2 to the server 5. With the aforementioned network device 3 and server 5, consumers no longer need to spend a considerable amount of money to purchase the expensive call recorder or answering machine in order to achieve the voice recording and answering functions easily.

In the present invention, if the server 5 receives the phone content, the server 5 will create a phone voice file at a corresponding path in the database 6 according to an ID information of the network device 3 and store the phone content to the phone voice file. If the network device 3 detects an incoming call which is not answered by the local telephone 1 within a predetermined time, the network device 3 will generate a request signal to the server 5 to request a pre-recorded reply voice file to be transmitted. When the server 5 receives the request signal, the server 5 reads the reply voice file from the corresponding path of the database 6 and transmits the reply voice file to the network device 3 according to the ID information of the network device 3. When the network device 3 receives the reply voice file transmitted from the server 5, the network device 3 will play back the reply voice file to respond and reply to a user of the local telephone 10 at a remote end. After the reply voice file is played back, and the network device 3 receives a message content-transmitted from the public switched telephone network (PSTN) 2, the network device 3 will upload the message content to the server 5, and if the server 5 receives the message content, the server 5 will create a message voice file at a corresponding path in the database 6, and store the message content to the message voice file according to the ID information.

Referring to FIG. 1 for a preferred embodiment of the present invention, the answering and recording system sequentially installs a gateway 7 and a modem 8 between the network device 3 and the server 5, wherein the gateway 7 is a home gateway, and coupled to the network device 3 for connecting to the Internet 4, and the modem 8 is provided for connecting a broadband network equipment such as an asymmetric digital subscriber line (ADSL) or asymmetric digital circuit modem 8, cable modem or optical fiber for transmitting the phone content, the message content or the reply voice file to the Internet 4.

In the preferred embodiment as shown in FIG. 1, the ID information is a user account, and/or a device information (such as a device ID, a MAC address) of the network device 3 corresponding to the account, and the network device 3 includes a phone port 31, a PSTN port 32, a digital-to-analog converter 33, a processor 34, an Internet interface 35 and a network port 36, wherein the phone port 31 is provided for connecting at least one local telephone 1, and the PSTN port 32 is provided for connecting the public switched telephone network (PSTN) 2, and the digital-to-analog converter 33 is connected separately to the phone port 31, the PSTN port 32 and the processor 34, and the processor 34 is connected to the Internet interface 35, and the network port 36 is connected separately to the Internet interface 35 and the gateway 7.

If the digital-to-analog converter 33 receives the phone content or the message content, since the phone content and the message content are analog signals, the digital-to-analog converter 33 will carry out a digital conversion to the phone content or the message content to convert the phone content or the message content into a digital phone content or a digital message content respectively, and the processor 34 will transmit the digital phone content or the digital message content to the Internet interface 35, and the Internet interface 35 will carry out a network transmission to the digital phone content or the digital message content, so that the processed digital phone content or digital message content is passed through the gateway 7, the modem 8 and Internet 4 sequentially and transmitted from the network port 36 to the server 5 via the network transmission.

If the processor 34 detects an incoming call which is not answered by the local telephone 1 within the predetermined time, the processor 34 will generate the request signal and transmit the request signal to the Internet interface 35 for a network transmission, and the request signal processed by the network transmission is passed from the network port 36 through the gateway 7, the modem 8 and Internet 4 sequentially and transmitted to the server 5, and the server 5 will read the reply voice file from a corresponding path in the database 6 according to the ID information of the network device 3. The reply voice file processed by a network transmission is transmitted to the network device 3 through the Internet 4, the modem 8 and the gateway 7. If the Internet interface 35 receives the reply voice file, the reply voice file will be recovered and transmitted to the digital-to-analog converter 33, and the digital-to-analog converter 33 will receive the reply voice file, and an analog conversion will be performed to process and convert the reply voice file into the response content, and the response content will be played back via the PSTN port 32 and the public switched telephone network (PSTN) 2 for a user of a local telephone 10 at remote end to listen and reply the incoming call. Therefore, the invention can achieve the answering function by playing back the corresponding reply voice file according to different network devices 3.

In the preferred embodiment of the present invention as shown in FIG. 1, the server 5 is comprised of a network module 51, a recording module 53, a notice module 55 and a user interface 57 (such as a webpage), wherein the network module 51 is connected separately to the Internet 4, the recording module 53 and the notice module 55 for carrying out a data transmission between the server 5 and the Internet 4, and the recording module 53 is connected separately to the notice module 55, the database 6 and the user interface 57 for storing the digital phone content or the digital message content into the database 6.

If the network module 51 receives the digital phone content via the Internet 4, the network module 51 will recover and process the digital phone content and transmit the digital phone content to the recording module 53, and the recording module 53 will create the phone voice file at a corresponding path in the database 6 and store the digital phone content to the phone voice file according to the ID information. After the phone voice file is stored, the notice module 55 reads a notice data (corresponding to the ID information) stored in the server 5, and the network module 51 transmits the phone conversation information to the user according to the notice data. In the present invention, the notice data is an e-mail address, so that the phone conversation information can be attached to an e-mail and mailed to an e-mail box of a specified e-mail address. Further, the notice data can be a telephone number, so that the phone conversation information can be attached to a short message and sent to a telephone corresponding to the telephone number. However, the notice method of the invention is not limited to e-mail or short message, but the server 5 can sent a message such as a pop-up message to remind the noticed user when the user logs on a service webpage or uses an instant message software. In addition, the network device 3 can use an LED lamp to indicate a signal that there is a telephone notice. In view of the description above, when a user is not situated at the location of the local telephone 1 (such as home or office), the present invention not only can receive the notice via e-mail or short message and know about the calling status of the local telephone 1, but also can open the phone voice file to listen or access the phone content to avoid missing an important phone call. After the phone voice file is stored, the recording module 53 displays the filename of the phone voice file on a corresponding user interface 57 of the ID information according to the ID information, so as to maintain and display all communication records of the local telephone 1. Since the database 6 has a large storage space, therefore the insufficient storage capacity of traditional digital call recorders or answering machines will not occur here, and a user simply open the user interface 57 to select the phone voice file via the Internet 4 to listen or access the contents of a desired phone voice file.

If the network module 51 receives the request signal from the Internet 4, the network module 51 recovers the request signal first, and then transmits the request signal to the recording module 53, and the recording module 53 reads the reply voice file from a corresponding path in the database 6 according to the ID information, and transmits the reply voice file to the network module 51. After the network module 51 completes the network transmission of the reply voice file, the network modules 51 transmits the replay voice file to the network device 3 via the Internet 4 for the network device 3 to play the file.

If the network module 51 receives a digital message content via the Internet 4, the digital message content is recovered first and transmitted to the recording module 53, and then the recording module 53 creates the message voice file at a corresponding path in the database 6 according to the ID information and stores the digital message content to the message voice file. After the message voice file is stored, the notice module 55 reads a notice data (corresponding to the ID information) stored in the server 5 and sends the message to the user through the network module 51 according to the notice data. In this invention, the notice data is an e-mail address, so that the message can be attached to an e-mail and mailed to an e-mail box specified by the e-mail address. Further, the notice data can also be a telephone number, so that the message can be attached to a short message to be sent to a telephone corresponding to the telephone number. In addition, the notice method of the invention is not limited to the aforementioned e-mail or short message, but the server 5 can transmit a message such as a pop-up message to remind a noticed user when the user logs on a service webpage, or uses an instant message software. Further, the network device 3 can use an LED lamp to indicate a signal that there is a message notice. In summation of the description above, when a user is not at the location of the local telephone 1 (such as home or office), the user not only can receive a notice via e-mail or short message to know about the message of the local telephone 1, but the user also can open the message voice file to listen or access the message content, so as to avoid missing important phone calls.

In FIG. 1, the present invention stores and reads answers and records of telephone voice via the Internet, and the method is applied to the aforementioned system. In the method, if the network device 3 detects an incoming call which is not answered by the local telephone 1 within a predetermined time (such as 30 seconds) or after a predetermined number of rings, the network device 3 will start a telephone answering mechanism to read a response content pre-stored in the server 5 via the Internet 4, and then output the response content to the public switched telephone network (PSTN) 2 to reply the incoming call. If the network device 3 receives a message content transmitted from the public switched telephone network (PSTN) 2, the network device 3 will upload and store the message content to the server 5 via the Internet 4. Therefore, consumers not only can use the network device 3 to achieve the voice answering and recording functions easily without the need of purchasing expensive answering machines, but consumers also can read the message content from the server 5, so as to greatly enhance the convenience of reading the message content and using the voice answering and recording functions.

In FIG. 1, the method in accordance with a preferred embodiment of the present invention determines if the local telephone 1 has not picked up an incoming call from the public switched telephone network (PSTN) 2 according to the following procedure. Firstly, the network device 3 detects whether or not there is an incoming call from the public switched telephone network (PSTN) 2; if yes, and the incoming call from the public switched telephone network (PSTN) 2 is not picked up by any one of the local telephones 1, and the incoming call from the public switched telephone network (PSTN) 2 is not picked up within the predetermined time, then the network device 3 will start a telephone answering mechanism to carry out the answering and recording function with a user of a local telephone 10 at a remote end.

In the preferred embodiment as shown in FIG. 1, if the incoming call from the public switched telephone network (PSTN) 2 is picked up by any one of the local telephones 1, it indicates that the local telephone 1 has started a phone conversation with a user of the local telephone 10 at a remote end, and the network device 3 will start a telephone recording mechanism according to a procedure comprising the steps of: recording the phone content, wherein the network device 3 detects whether or not any one of the local telephones 1 of the public switched telephone network (PSTN) 2 is situated at a calling status; if yes, then the network device 3 will start the telephone recording mechanism, receive a phone content between the local telephone 1 and the public switched telephone network (PSTN) 2 and upload and store the phone content to the server 5. Therefore, the phone content can be stored into server 5 when any one of the local telephones 1 connected to the network device 3 has a phone content. The present invention not only can save the phone content for later use, but also solve the problem of insufficient memory capacity of the digital call recorder or answering machine for storing many records of recorded contents.

In the preferred embodiment, the response content is stored in a reply voice file in a database 6 connected to the server 5, and the network device 3 downloads a reply voice file from the database 6, and plays back the reply voice file and outputs the replay voice file to the public switched telephone network (PSTN) 2 for a user of the local telephone 10 at a remote end to listen and reply the incoming call. If the network device 3 receives a message content from the public switched telephone network (PSTN) 2, the network device 3 will upload the message content to the server 5, and the server 5 will receive the message content and store the message content into the database 6 according to an ID information (such as a device ID or a MAC Address) of the network device 3.

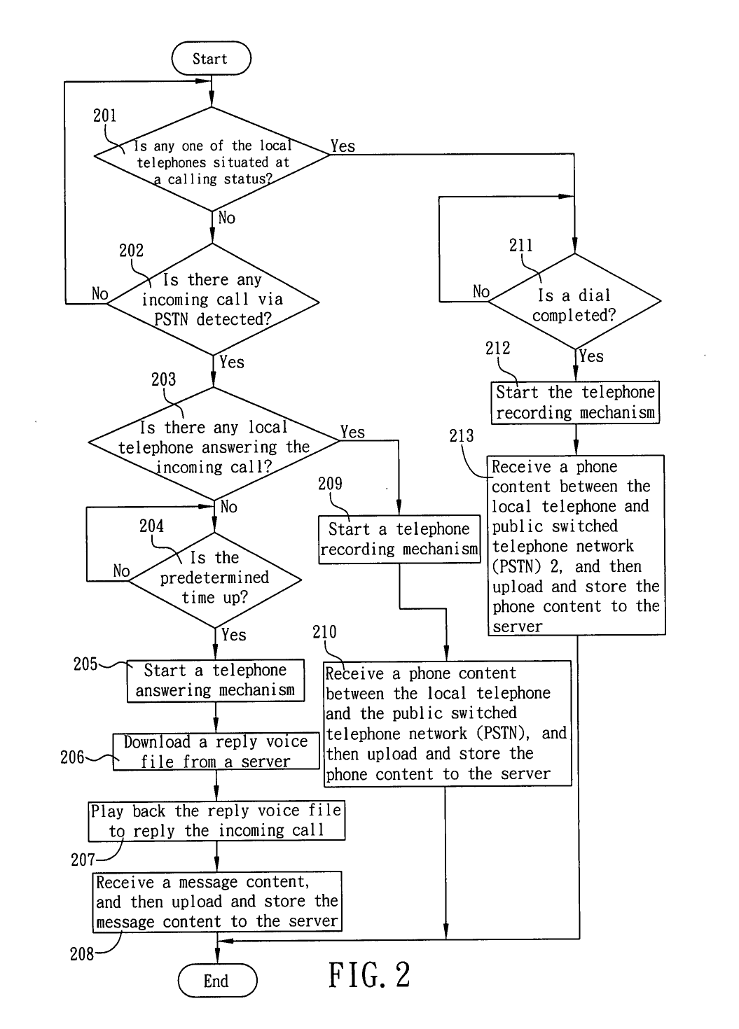

Referring to FIG. 2 for a clear description of the method in accordance with the present invention, the network device 3 carries out a procedure comprising the following steps:
Step (201): The network device 3 detects whether or not any one of the local telephones is picked up; if yes, then go to Step (211), or else go to Step (202).
Step (202): The network device 3 detects whether or not there is an incoming call from the public switched telephone network (PSTN) 2; if yes, then go to Step (203), or else return to Step (201).
Step (203): The network device 3 detects whether or not any of the local telephones 1 answers the incoming call from the public switched telephone network (PSTN) 2; if yes, then go to Step (209), or else go to Step (204).
Step (204): This step determine whether or not the predetermined time is reached; if yes, go to Step (205), or else return to Step (204).
Step (205): The network device 3 starts a telephone answering mechanism.
Step (206): The network device 3 download the reply voice file from the server 5.
Step (207): The network device 3 plays back the reply voice file and outputs the reply voice file to the public switched telephone network (PSTN) 2 for a user of a local telephone 10 at a remote end to listen.
Step (208): The network device 3 receives a message content from the public switched telephone network (PSTN) 2 and uploads and stores the message content to the server 5 via the Internet 4.
Step (209): The network device 3 starts a telephone recording mechanism.
Step (210): The network device 3 receives a phone content between the local telephone 1 and the public switched telephone network (PSTN) 2, and uploads and stores the phone content to the server 5.
Step (211): The network device 3 detects whether or not the local telephone 1 completes dialing a call; if yes, go to Step (212), or else return to Step (211).
Step (212): The network device 3 starts a telephone recording mechanism.
Step (213): The network device 3 receives a phone content between the local telephone 1 and the public switched telephone network (PSTN) 2, and uploads and stores the phone content to the server 5.

With the aforementioned procedure of the present invention, the network device 3 can start the telephone recording mechanism to record a phone content between the local telephone 1 and a user of another local telephone 10 or the network device 3 can start a telephone answering mechanism to record a message content transmitted from the public switched telephone network (PSTN) 2.

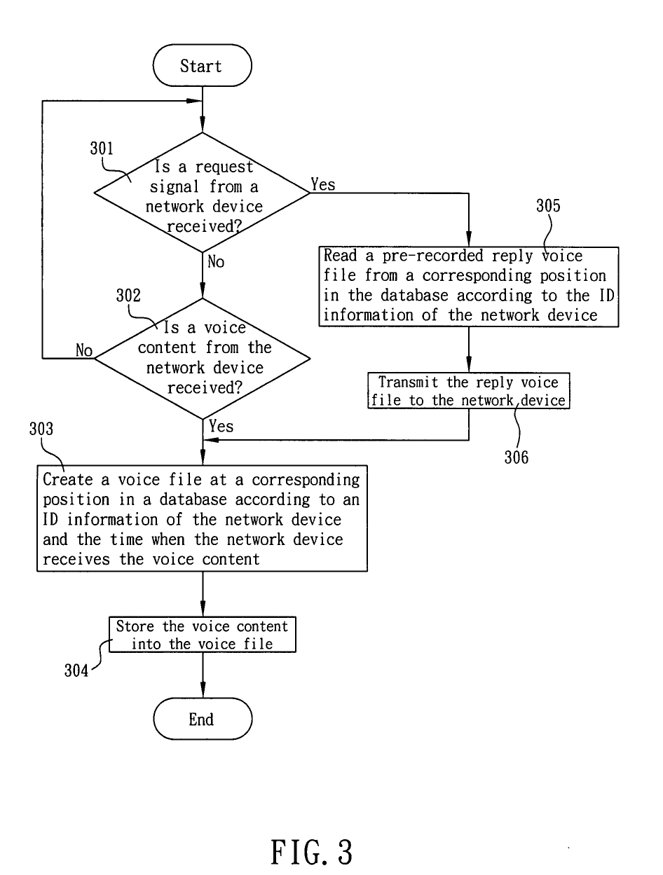

In the preferred embodiment, the server 5 must complete the following steps to successfully complete the operation of the telephone recording mechanism or telephone answering mechanism as shown in FIG. 3:
Step (301) Determine whether or not a request signal transmitted from the network device 3 is received; if no, then go to Step (302), or else go to Step (305). In the present invention, the request signal is generated after the network device 3 starts the telephone answering mechanism, for requesting the server 5 to transmit the reply voice file to the network device 3 and play back the network device 3.
Step (302): Determine whether or not a voice content transmitted from the network device 3 is received; if yes, then go to Step (303), or else go to Step (301). In the present invention, the voice content is the phone content or the message content read by the network device
Step (303): Create a voice file at a corresponding path in the database 6 according to an ID information of the network device 3 and the time (such as date, hour and minute) when the network device 3 receives the voice content.
Step (304): Store the voice content received by the server 5 to the voice file, wherein the voice content can be a phone content or a message content, and the server 5 separately stores the phone content as the phone voice file according to the received voice content, or stores the message content as the message voice file. In the present invention, the file format of the message voice file or the phone voice file can be motion picture coding expert group audio layer-3 (MP3) file, or a wave file (WAV), but the invention is not limited to the aforementioned MP3 or wave file format, and any other digital compressed format or uncompressed file format can be used as well.
Step (305): Read the pre-stored reply voice file from the corresponding path of the database 6 according to an ID information of the network device 3.
Step (306): Transmit the reply voice file to the network device 3 via the Internet 4 for the network device 3 to play back the reply voice file.

Therefore, the method of the invention can store several records of message voice files or phone voice files into the database 6 to effectively improve the traditional digital call recorder or answering machine being restricted by its storage capacity and incapable of storing several records of message contents. In addition, another user having the right to listen or access to the message voice file or the phone voice file can use another digital electronic device (such as a notebook computer, a mobile phone or a personal digital assistant (PDA)) to listen to or access the message voice file or phone voice file via the Internet 4, so as to greatly enhance the convenience of using the message voice file or the phone voice file.

In summation of the description above, the system and the method in accordance with the present invention can achieve the following effects and purposes:
1. Consumers no longer need to purchase expensive call recorder or answering machine or any other additional equipment to easily achieve the voice recording and answering functions by utilizing the existing network device 3.
2. The invention stores the message voice file and the phone voice file in the database 6, and thus not only avoiding the drawbacks derived from the traditional analog call recorder or answering machine that adopts magnetic tape as storage medium as well as overcoming the shortcoming of the digital call recorder or answering machine having an insufficient memory capacity.
3. Since the message voice file and the phone voice file are stored in the database 6, a user having the right to listen or access the message voice file and phone voice file can listen or access the phone content or the message content from a remote end via the Internet 4, so as to thoroughly solve the problem of a digital call recorder or answering machine that cannot transfer the recorded content to another playback device.
4. If the user is not at the location of the local telephone 1 (such as the user's home or office), a notice by e-mail or short message for noticing the user about a message left in the local telephone 1 can be received, and the user can open the message voice file to listen to the message, so as to learn about the message content quickly.
5. The present invention lists the filenames of all phone voice files of the local telephone 1 on a webpage, so that users of the local telephones 1 can browse and select the phone voice files in order to listen or access the contents of the phone voice files.

While the invention has been described by means of specific embodiments, numerous modifications and variations could be made thereto by those skilled in the art without departing from the scope and spirit of the invention set forth in the claims.

What is claimed is:

1. A system for storing and reading answers and records of telephone voice via Internet, comprising:
a network device;
at least one local telephone, connected to a public switched telephone network (PSTN) through the network device; and
a server, connected to the network device via the Internet;
thereby, when the network device detects a telephone connection established between the local telephone and the public switched telephone network (PSTN), the network device will read a phone content between the local telephone and the public switched telephone network (PSTN) and transmit and store the phone content into the server, and when the network device detects an unanswered incoming call over a predetermined time at the local telephone, the network device will read a response content pre-stored in the server, output the response content through the public switched telephone network (PSTN) to reply the incoming call, and transmit and store the message content received from the public switched telephone network (PSTN) into the server.

2. The system as recited in claim 1, wherein when the network device detects an incoming call not answered at the local telephone within the predetermined time, the network device will generate a request signal, transmit the request signal to the server, and request the server to transmit the response content to the network device.

3. The system as recited in claim 2, wherein the server receives the request signal, reads pre-recorded reply voice file from a corresponding path of a database coupled to the server according to ID information of the network device, and transmits the reply voice file to the network device.

4. The system as recited in claim 3, wherein the system between the network device and the server further comprises:
a gateway, connected to the network device; and
a modem, connected separately to the gateway and the Internet.

5. The system as recited in claim 4, wherein the network device further comprises:
a phone port, for connecting the local telephone;
a PSTN port, for connecting the public switched telephone network (PSTN);
a digital-to-analog converter, connected separately to the phone port and the PSTN port, for reading the phone content or the message content, and processing the phone content or the message content into a digital phone content or a digital message content respectively, or receiving the reply voice file, and performing an analog conversion for the reply voice file to generate the response content; and
a processor, coupled to a digital-to-analog converter, for detecting a phone connection status between the local telephone and the public switched telephone network (PSTN), and generating the request signal when detecting an incoming call which is not answered by the local telephone within the predetermined time.

6. The system as recited in claim 5, wherein the network device further comprises:
an Internet interface, connected to the processor, for receiving the digital phone content, the digital message content or the request signal, and processing a network transmission for the digital phone content, the digital message content or the request signal; and
a network port, connected to the Internet interface and the gateway, for transmitting the digital phone content, the digital message content or the request signal processed by network transmission, or receiving the reply voice file transmitted from the server.

7. The system as recited in claim 6, wherein the server comprises:
a network module, connected to the Internet, for receiving the digital phone content the digital message content or the request signal processed by the network transmission, and recovering the digital phone content, the digital message content or the request signal, or performing a network transmission for the reply voice file, and transmitting to the Internet; and
a recording module, connected separately to the network module and database, such that while the recording module is receiving the digital phone content, the recording module creates a phone voice file at a corresponding path in the database according to the ID information, and stores the digital phone content to the phone voice file, and while the recording module is receiving the digital message content, the recording module creates a message voice file at a corresponding path in the database according to the ID information and stores the digital message content to the message voice file, and when the recording module receives the request signal, the recording module reads the reply voice file from a corresponding path in the database according to the ID information, and transmits the reply voice file to the network module.

8. The system as recited in claim 7, wherein the server further comprises a notice module connected separately to the network module and the recording module, for transmitting the message voice file from the network module according to a notice data of the server corresponding to the ID information after the message voice file is stored.

9. The system as recited in claim 8, wherein the server further comprises a user interface connected to the recording module, and the recording module displays a filename of the phone voice file on a user interface corresponding to the ID information according to the ID information, after the phone voice file is stored.

10. A method for storing and reading answers and records of telephone voice via Internet, and the method being applied to an answering and recording system, and the system comprising at least one local telephone, a network device, a public switched telephone network (PSTN), an Internet and a server, and the method comprising:
the network device starting a telephone answering mechanism, when the network device detects an incoming call which is not answered by the local telephone within a predetermined time;
the network device reading a response content pre-stored in the server via the Internet;
the network device outputting the response content to the public switched telephone network (PSTN) to reply to the incoming call; and
the network device receiving a message content transmitted from the public switched telephone network (PSTN), and then uploading and storing the message content into the server via the Internet.

11. The method as recited in claim 10, further comprising the steps of:
the network device starting a telephone recording mechanism, when any one of the local telephones is situated at a calling status through the public switched telephone network (PSTN); and
the network device receiving a phone content between the local telephone and the public switched telephone network (PSTN), and uploading and storing the phone content into the server via the Internet.

12. The method as recited in claim 10, wherein the server stored the message content by a procedure comprising the steps of:
creating a message voice file at a corresponding path in a database coupled to server according to the ID information of the network device and the time when the network device receives the message content; and
storing the message content received by the server to the message voice file.

13. The method as recited in claim 11, wherein the server stores the phone content according to a procedure comprising the steps of:
creating a phone voice file at a corresponding path in a database coupled to the server according to the ID information of the network device and the time when the network device receives the phone content; and
storing the phone content received by the server to the phone voice file.

14. The method as recited in claim 12, wherein after the server stores the message content to the message voice file, the method further comprises the steps of:
reading a notice data in the server and corresponding to the ID information; and
sending out the message voice file via the Internet according to the notice data.

15. The method as recited in claim 11, wherein after the server stores the phone content to the phone voice file, the method further comprises the steps of:
reading a filename of the phone voice file; and
displaying the filename of the phone voice file on a user interface corresponding to the ID information.

16. The method as recited in claim 14, wherein after the network device starts a telephone answering mechanism, the server transmits the response content to the network device according to a procedure comprising the steps of:
receiving a request signal when the network device starts the telephone answering mechanism;
reading the response content from a corresponding path of the database according to the ID information of the network device; and
transmitting the response content to the network device.

17. The method as recited in claim 15, wherein after the network device starts a telephone answering mechanism, the server transmits the response content to the network device according to a procedure comprising the steps of:
receiving a request signal when the network device starts the telephone answering mechanism;
reading the response content from a corresponding path of the database according to the ID information of the network device; and
transmitting the response content to the network device.

18. A method for storing and reading answers and records of telephone voice via Internet, and the method being applied to an answering and recording system, and the system comprising at least one local telephone, a network device, a public switched telephone network (PSTN), an Internet and a server, and the method comprising the steps of:
the network device starting a telephone recording mechanism when any one of the local telephones is situated at a calling status through the public switched telephone network (PSTN); and
the network device receiving a phone content between the local telephone and the public switched telephone network (PSTN), and uploading and storing the phone content into the server through the Internet.

19. The method as recited in claim 18, wherein the server stores the phone content by a procedure comprising the steps of:
creating a phone voice file at a corresponding path in a database coupled to the server according to the ID information of the network device and the time when the network device receives the phone content; and
storing the phone content received by the server to the phone voice file.

20. The method as recited in claim 19, wherein after the server stores the phone content to the phone voice file, the method further comprises the steps of:
reading a filename of the phone voice file; and
displaying the filename of the phone voice file on a user interface corresponding to the ID information.
